(19) United States
(12) Patent Application Publication
(10) Pub. No.: US 2008/0010608 A1
(43) Pub. Date: Jan. 10, 2008

(54) Apparatus and methods for ensuring visibility of display window

(75) Inventor: James S. Adams, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC.

(21) Appl. No.: 11/481,362

(22) Filed: Jul. 5, 2006

(51) Int. Cl. G06F 9/00; G06F 3/00

(52) U.S. Cl. 715/781; 715/791; 715/790; 715/788; 715/796

(57) ABSTRACT

Devices, systems and methods for controlling displays in a multi-display environment are disclosed. The exemplary system may include a module for intercepting display creations from the display system. A module makes a determination whether the intercepted display is a dialog display and, if so, promotes the display status of that display to an always-on-top status, thereby ensuring the display's visibility.

### FIELD OF THE INVENTION

The present invention relates to a display system, and more particularly, to a method for organizing software application display to ensure visibility of displays.

### BACKGROUND OF THE INVENTION

In control room environments, a computer user may miss critical information due to occlusion by other displays. For the casual user, this can be seen when viewing Windows XP's “task manager” and then attempting to launch a program using XP's Start>Run . . . command. The system response window may be hidden from the user in this case by the task manager display, which may be granted “always on top” status. Similarly, operators depend on visibility of process control graphic displays. Operator interactions may be occluded by other such displays. If the occluded interaction is a “message box” or any other kind of modal dialog display awaiting operator response, then the dialog's owning display, or even the entire system, may become non-responsive to subsequent operator-initiated interactions. In this case, the user or operator often believes the product has become unresponsive, or “frozen”. An operator of process control graphic displays may assume a platform for controlling critical processes is therefore unsuitable.

Accordingly, an efficient and effective system is needed for ensuring that human-computer interaction display windows are properly displayed and are not going to be hidden from the operator's view.

### SUMMARY OF THE INVENTION

It is, therefore, an objective of the present invention to provide devices, systems, and methods of controlling displays in a multi-display environment.

In one embodiment, an exemplary method intercepts display creation requests from the operating system. The method determines whether the display is a human-computer interaction (a pop-up, or dialog display, hereafter referred to as a ‘dialog’ or ‘dialog display’). If so, the method promotes the display status of the dialog display to always-on-top status. The display's visibility is thereby preserved when otherwise it may have been occluded.

In another embodiment, an exemplary method similarly modifies displays created in response to a request inputted to the display system. The method ascertains properties of the requested display and finds a match between those properties and an entry in a configuration file. The configuration file defines a display characteristic including predetermined display window status specified for the matching requested dialog display. When a match is determined, the method may promote the display status associated with the category of display to an always-on-top status. The display's visibility is thereby preserved when otherwise it may have been occluded.

According to an exemplary embodiment of the present invention, the system may incorporate the following embodiments. In one embodiment, the system promotes all dialog displays on a standard PC to always-on-top. In another exemplary embodiment, the configuration file defines display characteristics including predetermined display window status specified for the category of the requested display of pop-up and dialog displays. In yet another embodiment, the multi-display environment is a display system for a plant control network.

### BRIEF DESCRIPTION OF THE DRAWINGS

The above and other objectives and advantages of the present invention will be apparent upon consideration of the following detailed description, taken in conjunction with the accompanying drawings, in which like reference numbers refer to like parts throughout, and in which:

FIG. 1 shows a block diagram of a process control system of an exemplary embodiment in which the present invention can be utilized;

FIG. 2 shows a block diagram of common elements of each physical module of the process control system of FIG. 1;

FIG. 3 shows a functional block diagram of a typical physical module of the process control system;

FIG. 4 shows a block diagram of a Workspace Manager Display System of an exemplary embodiment;

FIG. 5 is a flow chart illustrating a first exemplary method of the present invention.

FIG. 6 is a flow chart illustrating a second exemplary method of the present invention.

### DETAILED DESCRIPTION OF THE INVENTION

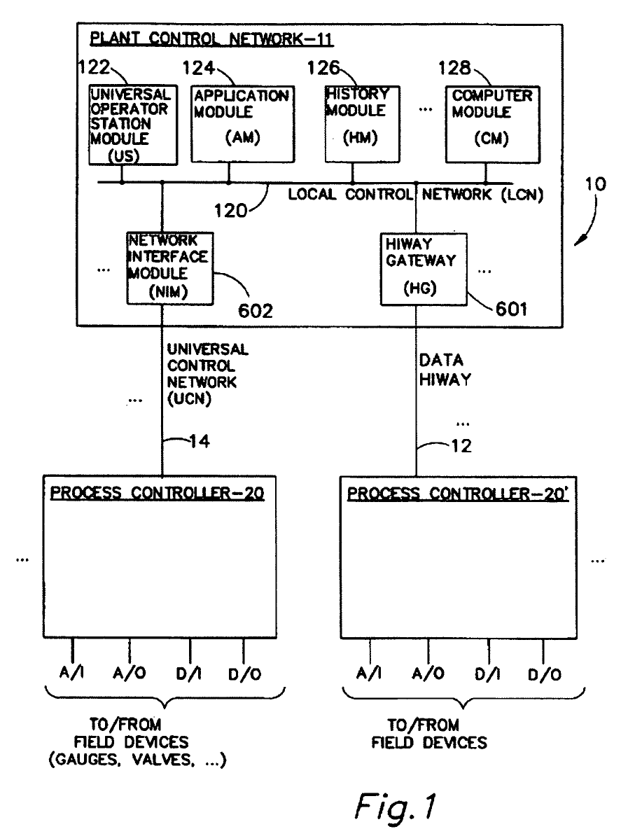

Before describing the method of the present invention, it will be helpful to understand a system environment in which the invention is utilized. Referring to FIG. 1, there is shown a block diagram of a process control system 10 of the preferred embodiment in which the present invention can be found. The process control system 10 includes a plant control network 11, and connected thereto is a data highway 12, which permits a process controller 20′ to be connected thereto. In the present day process control system 10, additional process controllers 20′ can be operatively connected to the plant control network 11 via a corresponding highway gateway 601 and a corresponding data highway 12. A process controller 20, an interface apparatus which includes many new additions, improvements, and features over the process controller 20′, is operatively connected to the plant control network 11 via a universal control network (UCN) 14 to a network interface module (NIM) 602. In the preferred embodiment of the process control system 10, additional process controllers 20 can be operatively connected to the plant control network 11 via a corresponding UCN 14 and a corresponding NIM 602. The process controllers 20, 20′ interface the analog input and output signals and digital input and output signals (A/I, A/O, D/I, and D/O respectively) to the process control system 10 from the variety of field devices (not shown) of the process being controlled which include valves, pressure switches, pressure gauges, thermocouples, etc.

The plant control network (or more simply the network) 11 provides the overall supervision of the controlled process in conjunction with the plant operator and obtains all the information needed to perform the supervisory function and includes an interface with the operator. The plant control network 11 includes a plurality of physical modules (or nodes), which include a universal operator station (US) 122, an application module (AM) 124, a history module (HM) 126, a computer module (CM) 128, and duplicates (backup or secondary) of these modules (and additional types of modules, not shown) as necessary to perform the required control/supervisory function of the process being controlled. Each of these physical modules is operatively connected to a local control network (LCN) 120, which permits each of these modules to communicate with each other as necessary. The NIM 602 and HG 601 provide an interface between the LCN 120 and the UCN 14 and the LCN 120 and the data highway 12, respectively.

Physical modules 122, 124, 126, 128, . . . of network 11 of the preferred embodiment are of various specialized functional types. Each physical module is the peer, or equivalent, of the other in terms of right of access to the network's communication medium, or LCN 120, for the purpose of transmitting data to other physical modules of the network 11.

Universal operator station module (US) 122 of network 11 is a workstation for one or more plant operators.

A history module (HM) 126 provides mass data storage capability. The history module 126 includes at least one conventional disk mass storage device, such as a Winchester disk, which disk storage device provides a large volume of nonvolatile storage capability for binary data. The types of data stored by such a mass storage device are typically trend histories, event histories, or data from which such histories can be determined, data that constitutes or forms CRT type displays, copies of programs for the physical modules.

An application module (AM) 124 provides additional data processing capability in support of the process control functions performed by the controllers associated with the process control subsystem 20, 20′ such as data acquisition, alarming, and batch history collection, and provides continuous control of computational facilities when needed. The data processing capability of the application module 124 is provided by a processor (not shown) and a memory (not shown) associated with the module.

Computer module (CM) 128 uses the standard or common units of all physical modules to permit a medium-to-large scale, general purpose data processing system to communicate with other physical modules of the network 11 and the units of such modules over the LCN 120 and the units of process control subsystems 20, 20′ via the highway gateway module 601, and the NIA4 602, respectively. Data processing systems of a computer module 128 are used to provide supervision, optimization, generalized user program preparation, and execution of such programs in higher-level program languages. Typically, the data processing systems of a computer module 128 have the capability of communicating with other such systems by a communication processor and communication fines.

The local control network 120 (LCN) is a high-speed, bit serial, dual redundant communication network that interconnects all the physical modules of plant control network 11. LCN 120 provides the only data transfer path between the principal sources of data, such as highway gateway module 601, application module 124, and history module 126, and principal users of such data, such as universal operator station module 122, computer module 128, and application module 124. LCN 120 also provides the communication medium over which large blocks of data, such as memory images, can be moved from one physical module, such as history module 126, to universal station module 122. LCN 120 is dual redundant in that it consists of two coaxial cables that permit the serial transmission of binary signals over both cables.

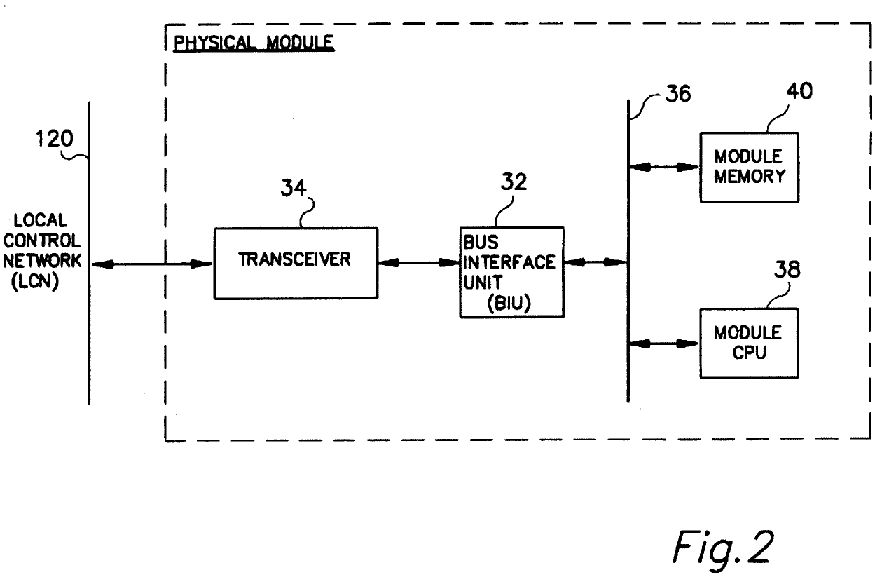

Referring to FIG. 2, there is shown a block diagram of the common elements of each physical module of the network 11 or the process control system 10. Each of the physical modules includes a module central processor unit 38 and a module memory 40, a random-access memory (not shown), and such additional controller devices, or units (not shown), which are configured to provide the desired functionality of that type of module, i.e., that of the operator station 122, for example. The data-processing capabilities of each module's CPU 38 and module memory 40 create a distributed processing environment that provides for improved reliability and performance of the network 11 and process control system 10. The reliability of network 11 and system 10 is improved because, if one physical module of network 11 fails, the other physical modules will remain operational. As a result, the network 11 as a whole is not disabled by such an occurrence as would be the case in centralized systems. Performance is improved by this distributed environment in that throughput and fast operator response times result from the increased computer processing resources and the concurrency and parallelism of the data-processing capabilities of the system.

As mentioned above, each physical module includes the BUS interface unit (BIU) 32, which is connected to the LCN 120 by the transceiver 34. Each physical module is also provided with the module BUS 36 which, in the preferred embodiment, is capable of transmitting 16 bits of data in parallel between the module CPU 38 and the module memory 40. Other units, utilized to tailor each type of physical module to satisfy its functional requirements, are operatively connected to module BUS 36 so that each such unit can communicate with the other units of the physical module via its module BUS 36. The BIU 32 of the physical module initiates the transmission of data over LCN 120. In the preferred embodiment, all transmissions by a BIU 32 are transmitted over the coaxial cables which, in the preferred embodiment, form the LCN 120.

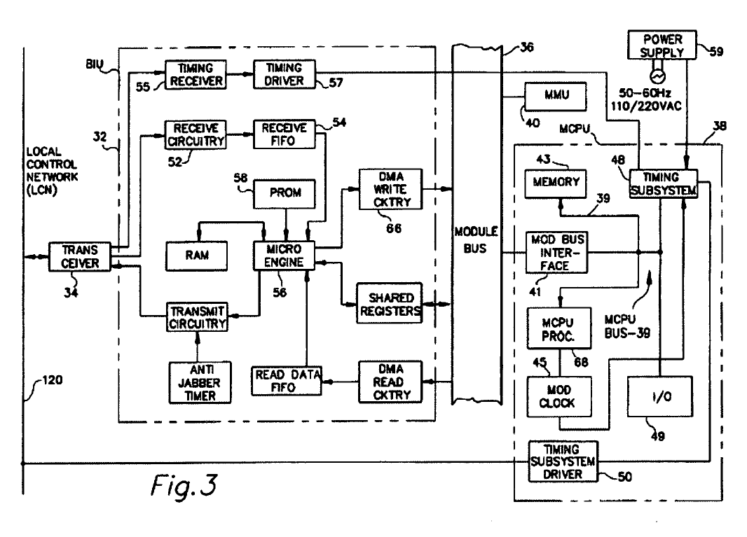

Referring to FIG. 3 there is shown a functional block diagram of a typical physical module 122, 124, 126, 128 of the plant control network 11, and includes the BUS 32 and the transceiver 34, which connects BIU 32 to the LCN 120. BIU 32 is capable of transmitting binary data over LCN 120 and of receiving data from LCN 120. Transceiver 34, in the preferred embodiment, is a transformer coupled to the LCN 120. In the preferred embodiment, the LCN 120 is a dual-redundant coaxial cable with the capability of transmitting bit serial data. BIU 32 is provided with a very fast micro-engine 56. In the preferred embodiment, micro-engine 56 is made up of bit slice components so that it can process eight bits in parallel and can execute a 24-bit microinstruction from its programmable read-only memory (PROM) 58.

Signals received from the LCN 120 are transmitted by transceiver 34 and receive circuitry 52 to receive FIFO register 54. Micro-engine 56 examines the data stored in FIFO register 54 and determines if the information is addressed to the physical module. If the data is an information frame, the received data is transferred by direct memory access (DMA) write circuitry 66 by conventional direct memory access techniques to the physical module memory unit (MMU) 40 over module BUS 36.

Communication between MCPU processor 68, a Motorola 68020 microprocessor in the preferred embodiment, and other functional elements of MCPU 38 is via local microprocessor BUS 39. Module BUS interface element 41 provides the communication link between local BUS 39 and module BUS 36. Processor 68 executes instructions fetched from either its local memory 43, in the preferred embodiment an EPROM, or from MMU 40. Processor 68 has a crystal-controlled clock 45 that produces clock pulses or timing signals. Input/output (I/O) port 49 provides communication between MCPU 38 and equipment external to the physical module to permit program loading and the diagnosis of errors, or faults, for example.

Each MCPU 38 includes a timing subsystem 48 which, in response to clock signals from module clock 45, produces fine resolution, synchronization, and real-time, timing signals. Any timing subsystem 48, which is provided with a timing subsystem driver 50, has the capability of transmitting timing information to other physical modules over the LCN 120. Another input to each timing subsystem 48 is timing information which is transmitted over LCN 120 and which is received through transceiver 34, timing receiver 55, and timing driver 57 of BIU 32. Timing pulses from module power supply 59, which are a function of the frequency of the external source of A.C. electric power applied to power supply 59, are used by timing subsystem 48 to correct longer-term frequency drift of the clock pulses produced by clock 45.

Additional information of the BIU 32 can be found in U.S. Pat. No. 4,556,974. A more detailed description of the process control system 10 can be had by referring to U.S. Pat. No. 4,607,256. Additional information of the individual, common, functional blocks of the physical modules can be had by reference to U.S. Pat. No. 4,709,347, all of the above-identified patents being assigned to the assignee of the present application; and additional information of the process controller 20′ can be had by referencing U.S. Pat. Nos. 4,296,464 5,796,403; 5,734,380.

The addition of an interface apparatus which interfaces other systems to the process control system 10 described above and a modification to a graphics generator in the US 122 opens up the existing system, specifically the graphics interface, which includes designing-in the capability to readily permit nodes of differing designs to communicate to with the network. In order to open up the graphics interface such that a display which is not on the LCN can be displayed onto the CRT 151 of the US 122, there is included an interface to a graphics card of the US 122 from a co-processor. For more detailed information regarding the opening of the graphics interface, reference can be made to U.S. Pat. No. 5,386,503, entitled “Method for Controlling Window Displays in an Open Systems Windows Environment,” and to U.S. Pat. No. 5,530,844, entitled “Method of Coupling Open Systems to a Proprietary Network,” both Pats. being assigned to the same assignee of the present application.

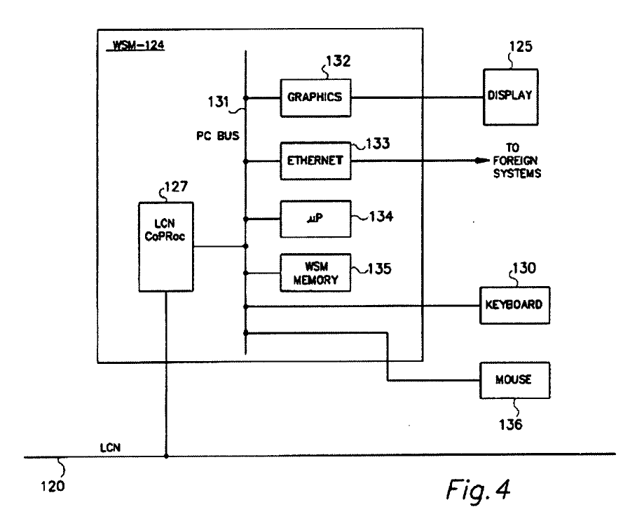

The display system which incorporates the method of the present invention will now be described. Referring to FIG. 4, there is shown a block diagram of a Workspace Manager (WSM) Display System of the preferred embodiment. The Workspace Manager Display System, or more simply referred to as Workspace Manager 124, is coupled to the LCN 120 of the process control system 10 in the preferred embodiment. The Workspace Manager (WSM) 124 is a personal computer (PC) which can be purchased in the marketplace, and includes an LCN co-processor 127 coupled to the LCN 120 and to an internal BUS (PCBUS) 131 of the PC (i.e., of the WSM 124). The LCN co-processor 127 includes the BIU 32, the module BUS 36, the module CPU 38, and the module memory 40, described above. This configuration permits the WSM 124 to communicate with the LCN 120 and the nodes connected thereto. The WSM 124 includes a graphics card 132 coupled to a display 125 and to the PC BUS 131. An Ethernet card 133 permits the WSM 124 to communicate with foreign systems (i.e., systems not coupled to the LCN 120). A microprocessor (up) 134 of the PC is coupled to the PC BUS 131 and executes the Operating System and the Workspace Manager software. A WSM memory 135 is also coupled to the PC BUS 131 and stores the various information (including a configuration file, which will be described later) for use by the up 134. A keyboard 130 and a mouse interface 136 may be used for inputting commands to the WSM 124.

In the microprocessor 134 of WSM 124 there is operating a workspace management program (i.e., software), which behavior has been modified according to the following behavior. The dialog display window is promoted to always-on-top status. This protocol may be implemented as a standard procedure for all pop-up and dialog displays or based on a window specification file.

A window specification file (sometimes referred to as a configuration file) is provided to the workspace management software. The window specification may be a set of window properties that can be applied to one or more real-application windows during runtime. These properties may include instructions for promoting the display status associated with the category of display to an always-on-top status. A plurality of window specifications can be included in a given workspace configuration. At runtime, once the workspace manager associates a real-application window with a particular window specification, that specification's properties are applied and enforced for that application window. For example, a display may be promoted to always-on-top status so that the new display will be in front of the user over other existing displays. The resolution to promote the display may be based on the category of the display being, for example, a pop-up or dialog display. The resolution to promote the display may also be based on the configuration file. The resolution to promote the display may also be based wholly separate from a configuration file, whereas all displays deemed pop-up or dialog displays are promoted similarly.

In the present invention, third-party applications can be dispositioned, not by category, but by title and process file (i.e., module) by matching expressions in the configuration file. A third-party application may specify which displays should be promoted to always-on-top status. For example, some applications associated with a display with a critical function may be promoted to always-on-top while a non-critical display or display that does not require immediate response may not be promoted.

In an exemplary embodiment, the features of the embodiment may be implemented in SafeView products provided by Honeywell® and required for Experion® multi-window process control. In another exemplary embodiment, the features of the embodiment may be implemented in SafeView products provided by Honeywell® for Global User Station based process control. Embodiments may be implemented independently of a SafeView environment, in a manner that ensures promotion of the display status associated with the pop-up and dialog display to an always-on-top status. Embodiments may be implemented in SafeView, but not necessarily for process control applications, for example, in a generic Windows XP® environment in which the user might otherwise miss occluded dialogs behind an always-on-top ‘task manager’ display.

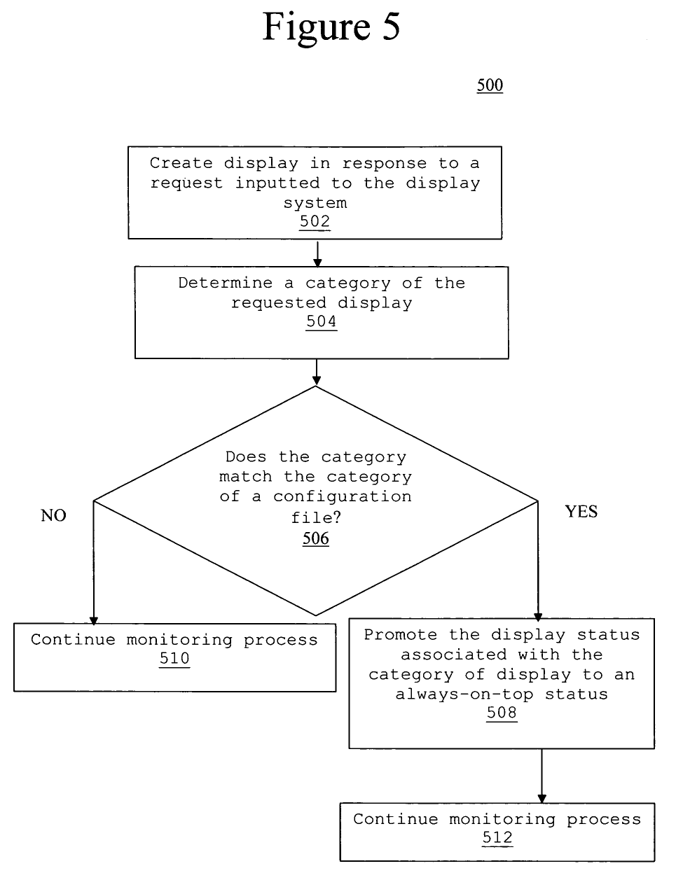

Referring to FIG. 5, a first exemplary method 500 may be implemented for control displays by the previously disclosed systems. A request to create a display is generated in response to a received request to the display system (block 502). The category of the requested display is determined (block 504). The process determines if the category matches the category of a configuration file (block 506)? If the category does not match (“No” branch of block 506), the monitoring process continues for the next display (block 510). If the category does match (“Yes” branch of block 506), the display status associated with the category of display is promoted to an always-on-top status (block 508). The display is presented in front of all other current displays. The monitoring process continues for the next display (block 512).

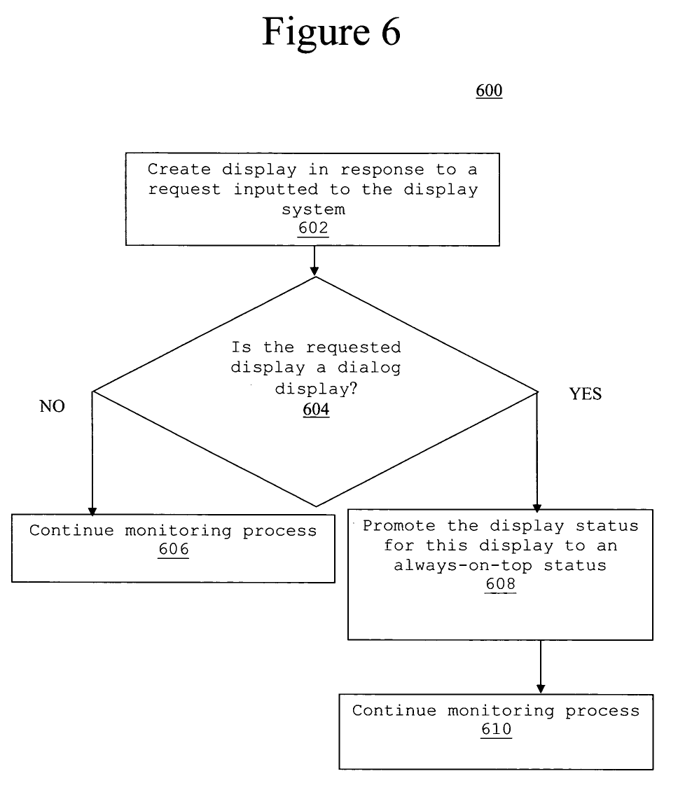

Referring to FIG. 6, a second exemplary method 600 may be implemented for control displays by the previously disclosed systems. A request to create a display is generated in response to a received request to the display system (block 602). The process determines if the newly requested display is a dialog display (block 604). If the new display is not a dialog display (“No” branch of block 604), the monitoring process continues for the next display (block 606). If the category does match (“Yes” branch of block 604), the display status associated with this display is promoted to an always-on-top status (block 608). The display is presented in front of all other current displays. The monitoring process continues for the next display (block 610).

The exemplary methods disclosed herein may be implemented in a variety of manners as previously discussed. The promotion of display status may be based on a windows configuration file, or as a standard protocol for every display generation request for displays to be of a given class, such as dialog displays. The display promotion is not limited to always-on-top status. The display may be promoted to other display statuses. Persons skilled in the art will appreciate that the present invention can be practiced by other than the described examples and embodiments, which are presented for purposes of illustration rather than of limitation and that the present invention is limited only by the claims that follow.

What is claimed is:

1. A method of controlling displays in a multi-display environment, comprising the steps of:
a) creating a display in response to a request inputted to the display system;
b) determining a category of the requested display;
c) finding a match between the category of the requested display and an entry in a configuration file, the configuration file defining display characteristics including predetermined display windows status specified for the category of the requested display;
d) when a match is determined, promoting the display status associated with the category of display to an always-on-top status.

2. A method of controlling displays according to claim 1, wherein the step of finding a match comprises the steps of:
a) searching the configuration file to obtain a match parameter;
b) comparing the match parameter to the category of the requested display;
c) when a match is found,
i) proceeding to step d) of claim 1; otherwise
ii) repeating step a) of claim 2 until the entire configuration file is searched.

3. A method of controlling displays according to claim 1, wherein the step of creating an application display comprises the steps of:
a) decoding the request inputted;
b) fetching a display file corresponding to the requested input; and
c) obtaining the data required by the display file to create the application display.

4. A method of controlling displays according to claim 1, wherein the configuration file defines display characteristics including predetermined display windows status specified for the category of the requested display of pop-up and dialog displays.

5. A method of controlling displays according to claim 1, wherein the multi-display environment is a display system for a plant control network.

6. A method of controlling displays in a multi-display environment, comprising the steps of:
a) receiving displays created in response to a request display inputted to a display system;
b) determining whether the requested display is a dialog display;
c) when the requested display is determined to be a dialog display, promoting the display status associated with that requested display to an always-on-top status.

7. A method of controlling displays of claim 6, wherein the multi-display environment is a display system for a plant control network.

8. A method of controlling displays of claim 6, wherein the dialog display is any display requesting user interaction.

9. A method of controlling displays of claim 6, wherein the step of receiving displays created in response to a request display inputted to a display system involves intercepting the displays.

10. A device for controlling displays in a multi-display environment, comprising:
a module for creating display in response to a request inputted to the display system;
a module for determining a category of the requested display;
a module for finding a match between the category of the requested display and an entry in a configuration file, the configuration file defining display characteristic including predetermined display windows status specified for the category of the requested display;
a module for promoting the display status associated with the category of display to an always-on-top status when a match is determined.

11. A device for controlling displays according to claim 10, wherein the module for finding a match further comprises:
a module for searching the configuration file to obtain a match parameter;
a module for comparing the match parameter to the category of the requested display;
c) when a match is found,
i) proceeding to the module for promoting the display status of claim 11; otherwise
ii) repeating a module for searching of claim 11 until the entire configuration file is searched.

12. A device for controlling displays according to claim 10, wherein the module for creating an application display further comprises:
a module for decoding the request inputted;
a module for fetching a display file corresponding to the requested input; and
a module for obtaining the data required by the display file to create the application display.

13. A device for controlling displays according to claim 10, wherein the configuration file defining display characteristic includes predetermined display windows status specified for the category of the requested display of pop-up and dialog displays.

14. A device for controlling displays according to claim 10, wherein the multi-display environment is a display system for a plant control network.
